(19) United States
(12) Patent Application Publication
(10) Pub. No.: US 2007/0071422 A1
(43) Pub. Date: Mar. 29, 2007

(54) Electric tool

(76) Inventors: Yoshikazu Kawano, Ibaraki (JP); Nobuhiro Takano, Ibaraki (JP); Teruo Imai, Ibaraki (JP); Shinichi Sakuma, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/525,830

(22) Filed: Sep. 25, 2006

(30) Foreign Application Priority Data
Sep. 26, 2005 (JP) P2005-278101

(51) Int. Cl. H02P 7/288

(52) U.S. Cl. 388/838

(57) ABSTRACT

An electric tool having an inexpensive revolution speed control unit, the life of which is long. According to the intended use, the revolution speed of the motor can be changed from a low speed to a high speed and the revolution speed of the motor can be finely set only in the low speed region. The electric tool includes a semiconductor element for controlling a voltage impressed upon a motor; and a setting means for setting an electric continuity angle of the semiconductor element, the setting means including a variable resistance means for changing a value of resistance and also including and an opening and closing means, which is interlocked with the variable resistance means, for conducting an opening and closing operation after the value of resistance has reached a predetermined value, wherein an electric continuity angle of the semiconductor element, and when electric continuity angle of the semiconductor element has reached a predetermined angle, the semiconductor element is changed over to a direct electric continuity state via the opening and closing means.

### BACKGROUND OF THE INVENTION

The present invention relates to an electric tool having a revolution speed control unit for controlling a revolution speed of a motor.

Concerning an electric tool, a method of changing a revolution speed of a motor of the electric tool is well known, by which the revolution speed of the motor is changed when a voltage to be impressed upon the motor is controlled with a semiconductor element such as SCR or TRIAC according to the intended use of the electric tool. Depending upon the type of an electric tool, according to the intended use of the electric tool, it is possible to change a revolution speed of the motor in a range from a low speed to a high speed and further it is necessary to make a fine setting on the revolution speed only in a low speed region. Therefore, a revolution speed control unit is provided in which only a half wave region of a voltage impressed upon the motor can be changed by SCR and it is possible to change over between the half wave drive (low speed revolution) and the full wave drive (high speed revolution) by a switch. An example of this revolution speed control unit is shown in FIG. 2.

As shown in FIG. 2, a revolution speed control unit 204 includes: resistors 205, 207; condensers 206, 216; diodes 208, 215; DIAC 214; SCR 213; and a dial 209 having a switch 210 and a variable resistor 211. In the case of driving a motor 203, first of all, an electric power switch 202 is turned on so as to supply a voltage from AC power source 201 to the revolution speed control unit 204. The condenser 206 is gradually charged with voltage by a half wave rectification circuit including the resistor 205, condenser 206 and diode 208. After that, a voltage of the condenser 206 is divided by the variable resistor 211 and the resistor 207. The thus divided voltage is impressed upon the condenser 216 and DIAC 214 via the diode 215. When a terminal voltage of the condenser 216 exceeds a certain value, this DIAC is turned on. When this DIAC is turned on, a trigger signal is sent to a gate of SCR 213, so that SCR 13 can be put into a state of electric continuity. As a result, a voltage is impressed upon the motor 203, and the motor 203 is turned according to the voltage value impressed upon the motor 203. In this case, when the dial 209 is rotated, a value of resistance of the variable resistor 211 is changed. As a result, a period of time, which is required for DIAC 214 to be turned on, is changed according to the time constant determined by the variable resistor 211 and the condenser 216. Accordingly, an electric continuity angle of SCR 213 is changed. Therefore, it is possible to change a revolution speed of the motor 203. In this way, the motor 203 can be subjected to half wave drive.

On the other hand, in the case of the full wave drive of the motor 203, when the dial 209 is turned, a value of resistance of the variable resistor 211 is changed. When the dial 209 is turned to an arbitrary angle, the switch 210 is turned on. As a result, SCR 213 is short-circuited by the switch 210. Therefore, the motor 203 is directly impressed with a voltage, which is sent from the AC power supply 201, via the switch 210. Accordingly, the motor 203 is turned at a high speed by the full wave drive.

Patent Document 1 discloses a control circuit for controlling a revolution speed of a motor when a drive operation is changed over between the half wave drive and the full wave drive.

Patent Document 1

JP-UM-A-48-88912]

However, in the method shown in FIG. 2, when the full wave drive is conducted, an electric current supplied to the motor 203 flows in the switch 210. Therefore, a capacity of the switch 210 must be sufficiently large so that a high intensity of electric current can flow in the switch 210. Further, when a changeover operation is conducted between the half wave drive and the full wave drive, since a high intensity of electric current flows in the switch 210, sparks are generated in a contact portion of the switch 210. Accordingly, there is a possibility that the contact portion of the switch 210 is melted by the sparks.

According to the method described in Patent Document 1, although a changeover operation is conducted between the half wave drive and the full wave drive, since the time at which TRIAC is turned on is determined by the condenser, it is impossible for the motor to turn at a full speed.

### SUMMARY OF THE INVENTION

The present invention has been accomplished to solve the above problems. An object of the present invention is to provide an electric tool having an inexpensive revolution speed control unit, the life of which is long, characterized in that: according to the intended use, the revolution speed of the motor can be changed from a low speed to a high speed (full speed); and the revolution speed of the motor can be finely set only in the low speed region.

The above object can be accomplished by an electric tool including a semiconductor element for controlling a voltage impressed upon a motor; and a setting means for setting an electric continuity angle of the semiconductor element, the setting means including a variable resistance means for changing a value of resistance and also including an opening and closing means, which is interlocked with the variable resistance means, for conducting an opening and closing operation after the value of resistance has reached a predetermined value, wherein an electric continuity angle of the semiconductor element is changed by the variable resistance means, and when electric continuity angle of the semiconductor element has reached a predetermined angle, the semiconductor element is changed over to a direct electric continuity state via the opening and closing means.

The above object can be accomplished by an electric tool, in which the setting means includes an adjusting means for adjusting a minimum revolution speed of the motor.

According to the present invention, it is possible to conduct a changeover operation between the half wave drive and the full wave drive without making an electric current directly flow in a motor via an opening and closing means. Accordingly, it is unnecessary to use an opening and closing means of a large capacity that is sufficiently large to make a high intensity of electric current directly flow in the opening and closing means.

Since the minimum speed of revolution of the motor can be adjusted, the revolution speed control unit of the present invention can be applied to various electric tools.

### BRIEF DESCRIPTION OF THE DRAWINGS

FIG. 1 is a circuit diagram of a revolution speed control unit of an embodiment of the present invention;

FIG. 2 is a circuit diagram of an example of a revolution speed control unit of the prior art;

FIG. 3 is a plan view showing a structure of a dial;

FIG. 4 is a graph showing a characteristic of a revolution speed of a motor with respect to a rotary angle of a dial of an embodiment of the present invention; and

FIG. 5 is a perspective view showing an example in which an electric tool of the present invention is made to be a jig saw.

### DETAILED DESCRIPTION OF THE INVENTION

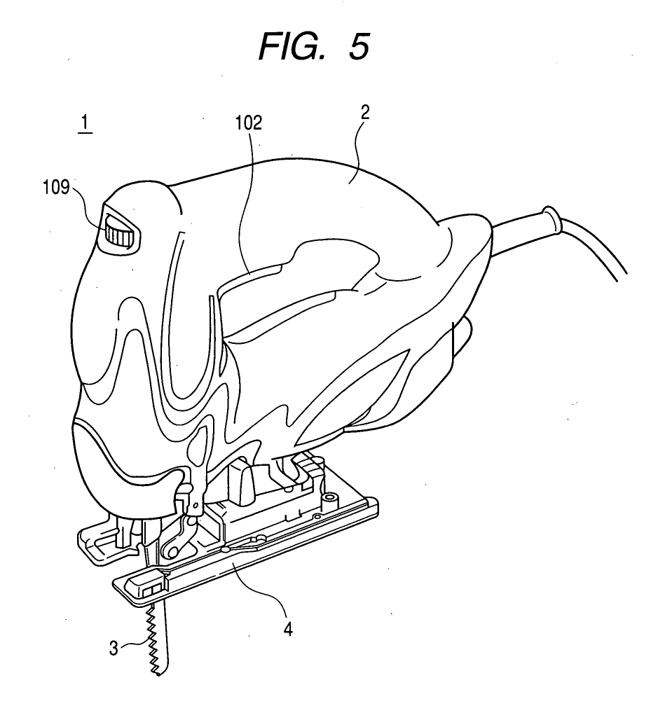

Referring to the drawings, an embodiment of the present invention will be explained in detail as follows. First, referring to FIG. 5, an electric tool of the present invention will be explained. In FIG. 5, an electric tool, that is, a jig saw 1 includes a handle 2 that a user holds; a saw blade 3 for sawing lumber; and a base 4 for holding the lumber. When the base 4 is set on the lumber and the user turns on a switch 102, a motor incorporated into the jig saw 1 is rotated and the rotation is converted into a reciprocating motion and transmitted to the saw blade 3, so that the lumber can be sawn. When a dial 109 is turned, it is possible to change over a revolution speed of the motor. When the dial 109 is turned, a revolution speed of the motor is changed. Therefore, it is possible to saw the lumber at a revolution speed suitable for the lumber, that is, it is possible to saw the lumber at a stroke number suitable for the lumber.

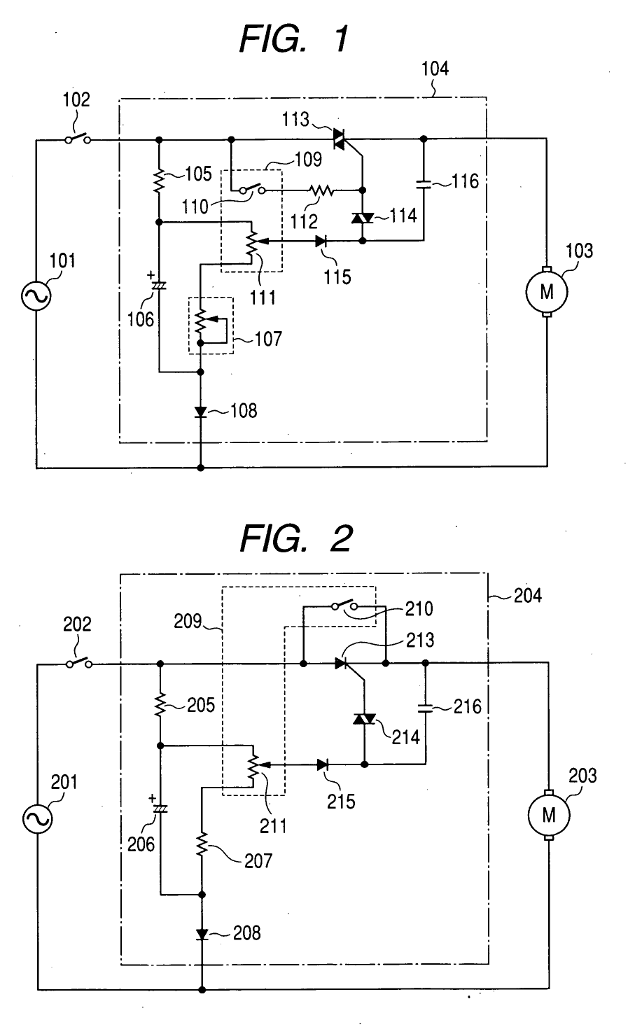

Next, the revolution speed control of the motor will be explained referring to FIG. 1. FIG. 1 is a view showing a revolution speed control unit for controlling the revolution speed of the motor. In FIG. 1, a revolution speed control unit 104 includes resistors 105, 112; a variable resistor 107 which becomes an adjusting means; condensers 106, 116; a diode 108, 115; DIAC 114; TRIAC 113 (semiconductor element); and a dial 109 having a switch 110, which becomes an opening and closing means, and also having a variable resistor 111 which becomes a variable resistor means. In this connection, the variable resistor 107 and the dial 109 compose a setting means of the present invention. In the case of driving a motor 103, first of all, an electric power switch 102 is turned on so as to supply a voltage from AC power source 101 to the revolution speed control unit 104. The condenser 106 is gradually charged with voltage by a half wave rectification circuit including the resistor 105, condenser 106 and diode 108. After that, a voltage of the condenser 106 is divided by the variable resistors 111, 107. The thus divided voltage is impressed upon the condenser 116 and DIAC 114 via the diode 115. When a terminal voltage of the condenser 116 exceeds a certain value, this DIAC 114 is turned on. When this DIAC 114 is turned on, a trigger signal is sent to a gate of TRIAC 113, so that TRIAC 113 can be put into a state of electric continuity. As a result, a voltage is impressed upon the motor 103, and the motor 103 is turned according to a voltage value impressed upon the motor 103. In this case, when the dial 109 is rotated, a value of resistance of the variable resistor 111 is changed. As a result, a period of time, which is required for DIAC 114 to be turned on, is changed according to the time constant determined by the variable resistor 111 and the condenser 116. Accordingly, an electric continuity angle of TRIAC 113 is changed. As a result, as shown in FIG. 4, it is possible to change a revolution speed of the motor 103. When the variable resistor 107 is adjusted, a ratio of dividing a voltage by the variable resistors 111, 107 is changed. Therefore, the time at which DIAC 114 is turned on is changed. Accordingly, it is possible to adjust the minimum revolution speed shown in FIG. 4.

Next, explanations will be made into a method of changing over between the half wave drive and the full wave drive. When the dial 109 is further turned to an arbitrary angle, that is, when the dial 109 is further turned to a switch operation angle shown in FIG. 4, the switch 110 is closed.

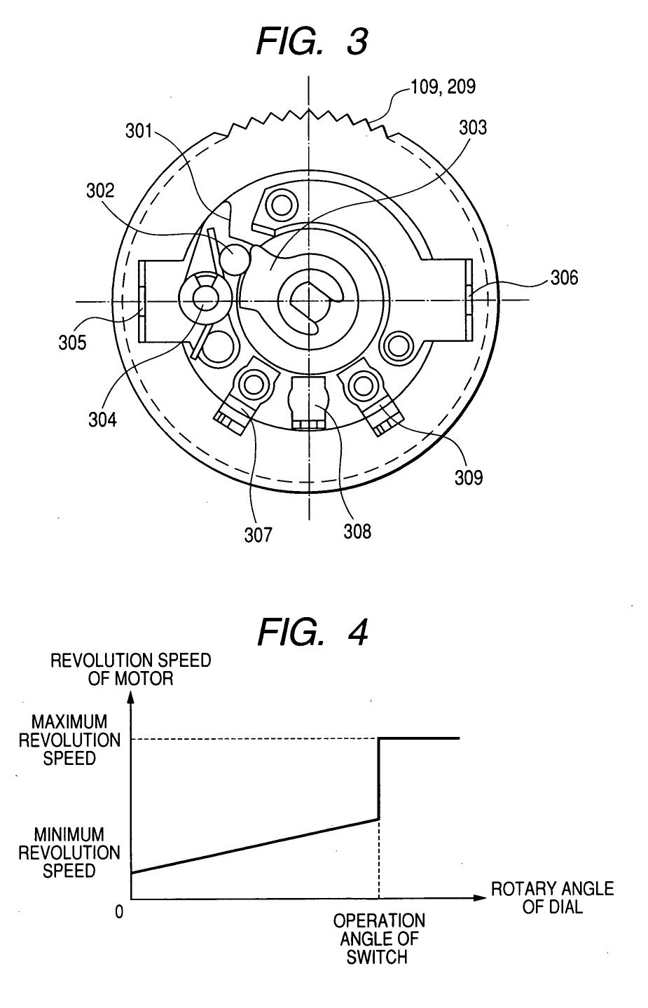

In this case, the dial 109 will be explained in detail referring to FIG. 3. In this connection, the dial 209 shown in FIG. 2 is composed in the same manner as that of the dial 109.

The dial 109 includes: a variable resistor 111 (variable resistor terminals 307, 308, 309); and a switch 110. The switch 110 includes: switch terminals 305, 306; a terminal 301; a pole 302; a stopper 303; and a coil spring 304. In the initial state (the state shown in FIG. 3), the pole 302 is pushed to an outer circumferential side by a protrusion of the stopper 303. Therefore, the terminal 301 is not contacted with the switch terminal 306 via the coil spring 304. That is, the condenser 106 is electrically charged by the half wave rectification circuit including the resistor 105, the condenser 106 and the diode 108, and the divided voltage is impressed upon DIAC 114 and the condenser 116. When the time at which DIAC 114 is turned on is changed according to the time constant of the variable resistor 111 and the condenser 116, a trigger signal to be impressed upon the gate terminal of TRIAC 113 is controlled. In this case, when the dial 109 is turned, the stopper 303 is turned being interlocked with the dial 109. Therefore, when a contact portion with the pole 302 coincides with a recess portion of the stopper 303, the pole 302 is released from the stopper 303, and the terminal 301 is joined to the switch terminal 306 via the coil spring 304. That is, the switch 110 is turned on and put into a state of electric continuity. Therefore, irrespective of a state of DIAC 114, a trigger signal is impressed upon the gate terminal of TRIAC 113 via the switch 110 and the resistor 112.

As a result, TRIAC 113 is not affected by the time at which DIAC 114 is turned on. Therefore, TRIAC 113 is put into a state of electric continuity in all regions of AC electric power supply 101. Accordingly, the motor 103 is subjected to the full wave drive. Accordingly, as shown in FIG. 4, the motor 103 can be rotated at the maximum revolution speed (the full speed). Further, the switch 110 is not arranged between AC electrical power supply 101 and the motor 103 but connected to the gate terminal of TRIAC 113. Therefore, it is possible to provide an electric tool, in which a high intensity of electric current does not flow in the switch 110, the manufacturing cost of which is low, and the life of which is long.

What is claimed is:

1. An electric tool comprising:
a semiconductor element for controlling a voltage impressed upon a motor; and
setting means for setting an electric continuity angle of the semiconductor element,
wherein the setting means includes variable resistance means for changing a value of resistance and and opening and closing means, which is interlocked with the variable resistance means, for conducting an opening and closing operation after the value of resistance has reached a predetermined value,
wherein an electric continuity angle of the semiconductor element is changed by the variable resistance means, and when the electric continuity angle of the semiconductor element has reached a predetermined angle, the semiconductor element is changed over to a direct electric continuity state via the opening and closing means.

2. An electric tool according to claim 1, wherein the setting means includes adjusting means for adjusting a minimum revolution speed of the motor.

3. An electric tool according to claim 1, further comprising:
a revolution speed control unit includes:
first and second resistors;
a first variable resistor which becomes an adjusting means;
first and second condensers wherein said first condenser is connected to said first resistor and said adjusting means;
a first diode which is connected to said first condenser and said adjusting means;
a second diode which is connected to said first condenser;
a DIAC which is connected to said second resistor, said second condenser and said second diode;
a TRIAC, being said semiconductor element, and connected to said DIAC and said second condenser; and
a dial having a switch, which becomes said opening and closing means, and also having a second variable resistor which becomes part of said variable resistance means, said dial being connected to said TRIAC, said first resistor, said first variable resistor, and said second diode.

4. An electric tool according to claim 2, further comprising:
a revolution speed control unit includes:
first and second resistors;
a first variable resistor which becomes an adjusting means;
first and second condensers wherein said first condenser is connected to said first resistor and said adjusting means;
a first diode which is connected to said first condenser and said adjusting means;
a second diode which is connected to said first condenser;
a DIAC which is connected to said second resistor, said second condenser and said second diode;
a TRIAC, being said semiconductor element, and connected to said DIAC and said second condenser; and
a dial having a switch, which becomes said opening and closing means, and also having a second variable resistor which becomes part of said variable resistance means, said dial being connected to said TRIAC, said first resistor, said first variable resistor, and said second diode.

5. An electric tool according to claim 3, wherein said first resistor is connected to a switch which control power to said electric tool.

6. An electric tool according to claim 4, wherein said first resistor is connected to a switch which control power to said electric tool.

7. An electric tool according to claim 3, wherein the motor is connected to said TRIAC, said second condenser and said first diode.

8. An electric tool according to claim 4, wherein the motor is connected to said TRIAC, said second condenser and said first diode.

9. An electric tool according to claim 5, wherein the motor is connected to said TRIAC, said second condenser and said first diode.

10. An electric tool according to claim 6, wherein the motor is connected to said TRIAC, said second condenser and said first diode.
